(19) United States
(12) Patent Application Publication
(10) Pub. No.: US 2013/0122292 A1
(43) Pub. Date: May 16, 2013

(54) Scotch® Tape or like Tear-line Indicator

(71) Applicant: Diana Carrdine, Lincroft, NJ (US)

(72) Inventor: Diana Carrdine, Lincroft, NJ (US)

(21) Appl. No.: 13/414,960

(22) Filed: Mar. 8, 2012

Related U.S. Application Data
(60) Provisional application No. 61/629,052, filed on Nov. 14, 2011.

(51) Int. Cl. C09J 7/02

(52) U.S. Cl. 428/354; 428/343

(57) ABSTRACT

A tape formed on a cylindrical core or roll, the tape having a layer of transparent or uniform color characteristic, an underside layer of adhesive material, and an interspersing within or adjacent to the adhesive layer of a coating of chemical material of a characteristic to change color when exposed to the air in providing a color contrast at a line of demarkation formed by the drawing of the tape from off the core or roll and cutting or twisting it off to a predetermined length, so as thereafter locate with ease a future length of tape to be withdrawn from the core or roll.

### CROSS-REFERENCE TO RELATED APPLICATIONS

A Provisional Patent Application covering the invention described herein was filed on Nov. 14, 2011, and assigned Ser. No. 61/629,052.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to adhesive tape wrapping materials, in general, and to a tape roll in which a torn or cut off edge can be easily visualized for further extension and later tear-off, in particular.

2. Description of the Related Art

As is well known and understood, Scotch® tape or like adhesives frequently are provided in a roll format. Such tape typically includes an adhesive backing, is usually transparent, and is commonly torn off from a roll by ripping along a saw-tooth plate or a fixture on which the roll revolves. Sometimes, on the other hand, where a tear-off plate is not provided, a cutting action by a scissor or other blade is employed to cut off a portion for securing various items in place, or in the wrapping of packages, to wind them tightly. In other instances, especially where the tape is wound around the item several times, the tape simply is just torn off by a biting action through the use of one's teeth, or by attempts to just manually cut it with a knife like-bladed device.

As will be appreciated, the problem with all this is that once the tape is cut, the user frequently experiences difficulty in locating the tear line on the remainder of the roll. This follows because the portion torn off, and the roll itself, are of the same coloration—leading to instances where the user has to then feel about to first locate by touch where that tear line is, so that a subsequent tear-off section can be effectuated. While this might be viewed as just an annoyance to a single-time user in taping a single package together, the problem becomes far more serious in a packaging department of a business, for example, where multiple numbers of items are to be readied for shipment as part of an industrial application. As will be acknowledged, the situation presents itself no matter the form of the cutting, no matter the construction of the tape dispenser used, and no matter the color or transparency of the tape—all due to the uniformity in terms of thickness and presentation that the modern-day tape material takes. Whether the roll be of Scotch® brand or not, these prior art rolls of packing tape, masking tape, and mending tapes all suffer the same undesirability—namely, a great deal of difficulty in locating the tear line other than through the instruments of one's own finger-feeling for site location. Then, even once the tear line is located, the next step is to alleviate the tearing off of the tape which by the definition of its implicit adhesive backing, adheres throughout its length across, over and around the remainder of the roll from which the torn-off portion is to come. However, in accordance with this invention, the following objectives will be appreciated as something that is needed to be attained.

### OBJECTS OF THE PRESENT INVENTION

It is an object of the present invention, therefore, to provide a new and improved manufacture of a Scotch® tape or like adhesive roll in which a tear-off line edge can easily be found.

It is object of the invention, also, to provide this manner of line or edge finding achievable no matter the method of tearing off the tape—whether it be by dispensing blade, scissor, biting or other knife-blade means.

It is another object of the invention to provide such edge indication without changing the overall appearance of the tape when on a roll, whether the roll be transparent or of a given color, and no matter what type of use the tape may be put—whether for securing, packing, mending or otherwise.

### SUMMARY OF THE INVENTION

As will become clear from the following description, the present invention envisions a tape formed on a cylindrical core or roll in which the tape has a layer of transparent or uniform color characteristic, an underside layer of adhesive material, and an interspersing within or adjacent to the adhesive layer of a coating of chemical material. In accordance with the invention, the chemical material exhibits a characteristic to change color when it is exposed to the air, in providing a color contrast at a line of demarkation formed by the drawing of the tape from off the core or roll and cutting or twisting it off to a predetermined length.

In a preferred embodiment of the invention, the underside layer is comprised of a pressure sensitive adhesive, which is nonreactive with the coating of chemical material either when the tape is on the core or roll, or drawn off it. Also, one or more chemical fixer materials could be added to stabilize or lengthen the time interval during which a color contrast is provided at the line of demarkation.

### BRIEF DESCRIPTION OF THE DRAWINGS

These and other features of the present invention will be more clearly understood from a consideration of the following description, taken in connection with the sole FIGURE of the drawing which illustrates a preferred embodiment of the tear-off line tape indicator of the invention.

### DETAILED DESCRIPTION OF THE INVENTION

In accordance with the invention, an adhesive tape is provided in the form of a cylindrical core or roll in which the tape has a layer of transparent or uniform color characteristic, with an underside layer of pressure-sensitive adhesive material.

Interspersed within the adhesive layer is a coating of chemical material—either uniformly throughout (or at random or uniform spacings) of a characteristic to change color when exposed to the air. Such chemicals are readily known to those in the chemical art and, in accordance with the invention, are of the ones to be selected—such that upon exposure to the air, they provide a color which contrasts both with the adhesive layer and with the tape itself. The chemicals to be employed will be specifically understood to be of a type which not only provides the contrast in color, but also will lend themselves to be easily torn from the tape by any appropriate cutting, knife-blade, biting, tearing or twist-off manners of separation.

Once separation follows, as will be understood, the rupturably exposed chemical component(s) react with the air in providing the color contrast at the tear line as a means of locating the edge of the tape that remains on the roll. At the same time, the similar contrast at the opposing end of the torn off separation will in no ways degrade the ability of the torn-off tape to secure the item being packaged—so no deleterious effects result. As will also be apparent to those skilled in the art, the adhesive tape as manufactured could also be provided with other “fixer chemicals” in stabilizing and lengthening the time interval during which the color contrast remains at the tear site line. The edge presented can then be found at a later date, for easy starting in those instances where repetitive use of the tear-off process is not immediately employed. This will be seen as an advantage in those applications where there are not several packagings, one after the other, as typifies many business operations.

In this foregoing type of usage, where a length of tape is drawn off the roll to be cut, the underside of the length of drawn off tape that remains and is pressed back onto the roll retains the color change right up to the tear line. The same type of color display is present when the drawn off tape is torn or twisted off; namely, the underside shines its color through the transparent, or color-contrasting, tape as an indication as to just where the edge is located for further tape deployment.

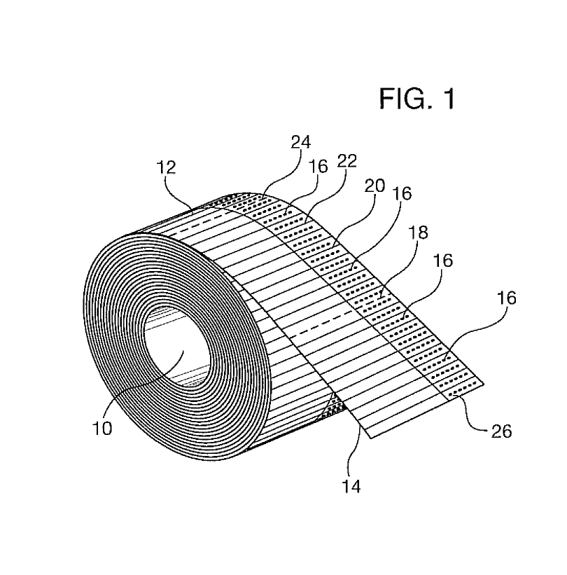

In this respect, FIG. 1 illustrates a core 10 around which a tape 12 (Scotch® brand tape or otherwise) is wound, with an adhesive layer underside 14, and an adjacent underside coating 16 of chemical material of the type to change color when drawn from the roll in exposure to the air. The prospective tear line is shown at 18, back from which the color change takes place to line 20 where the draw off begins. From line 20 to line 22 and line 24, the color change has yet to take place as the drawing-off of the tape has not there started. And, as such, the color changing chemicals may be either fixed into the adhesive layer itself, as well as spaced alongside it, as depicted at 26 in FIG. 1.

While there have been described what are considered to be preferred embodiments of the invention, it will be readily appreciated by those skilled in the art that modifications can be made without departing from the scope of the teachings herein. For at least such reason, therefore, resort should be had to the claims appended hereto for a true understanding of the invention.

I claim:

1. A tape formed on a cylindrical core or roll, the tape having a layer of transparent or uniform color characteristic, an underside layer of adhesive material, and an interspersing within or adjacent to the adhesive layer of a coating of chemical material of characteristic to change color when exposed to the air, to provide a color contrast at a line of demarkation formed by the drawing of the tape from off the core or roll and cutting or twisting it off to a predetermined length.

2. The tape of claim 1 wherein the coating of chemical material and adhesive material are non-reactive to one another either when the tape is on the core or roll or after having been drawn-off the core or roll.

3. The tape of claim 2, also including one or more chemical fixer materials to stabilize or lengthen a term interval during which a color contrast remains at said line of demarkation.

4. The tape of claim 3 wherein said underside layer is composed of a pressure sensitive adhesive.
